(19) United States
(12) Patent Application Publication
(10) Pub. No.: US 2009/0155599 A1
(43) Pub. Date: Jun. 18, 2009

(54) CORROSION AND SCALE INHIBITION COMPOSITIONS AND METHODS OF USE THEREOF

(75) Inventors: Gene H. Zaid, Sterling, KS (US); Beth Ann Wolf, Hutchinson, KS (US); Larry I. Skaare, Williston, ND (US)

Correspondence Address: HOVEY WILLIAMS LLP, 10801 Mastin Blvd., Suite 1000, Overland Park, KS, 66210, US

(73) Assignee: JACAM CHEMICALS, LLC, Sterling, KS (US)

(21) Appl. No.: 12/392,557

(22) Filed: Feb. 25, 2009

Related U.S. Application Data
(62) Division of application No. 11/873,599, filed on Oct. 17, 2007.

(51) Int. Cl. B05D 3/10; B32B 27/38

(52) U.S. Cl. 428/418; 427/340

(57) ABSTRACT

Improved multi-component compositions are provided for treating metallic surfaces subjected to contact with hydrocarbons, such as producing well casings and downhole equipment, and transmission lines. The compositions include an epoxy, a cross-linking or curing agent for the epoxy (e.g., ethoxylated tallow amine), and a scale inhibitor including phosphonic acid or phosphonate moieties (e.g., an organic phosphonate such as DETA phosphonate). The compositions may be added to a well or transmission line as a unitary, three-component mixture, or the epoxy may be initially added, followed by the cross-linking or curing agent, and the scale inhibitor. The compositions provide long-term scale inhibition without the need for continuous metered addition of scale inhibitor

### CROSS REFERENCE TO RELATED APPLICATION

This is a divisional of identically titled application Ser. No. 11/873,599 filed Oct. 17, 2007, and is incorporated by reference herein in its entirety.

### BACKGROUND OF THE INVENTION

1. Field of the Invention

The present invention is broadly concerned with improved, multiple-component compositions for treatment of metallic surfaces subjected to flowing liquid or gaseous hydrocarbons (e.g., crude oil or natural gas) in order to provide both anti-corrosion and scale inhibition properties. More particularly, the invention is concerned with such compositions, methods of treating metallic surfaces using the compositions, and the resultant coated metal surfaces, wherein the compositions include an epoxy, a curing or cross-linking agent, and a scale inhibitor operable to react with the epoxy and provide long-term scale inhibition without the need for continuous addition of scale inhibitor.

2. Description of the Prior Art

It is well known that oil and gas wells are subject to extensive corrosion. Downhole equipment such as sucker rods, pump rods, tubing and casing are generally made of mild steel which is adversely affected by the production fluid of the well. The often high temperatures and acidic nature of the production fluids and formation waters magnifies these corrosion problems. Additionally, oil or gas-conveying pipelines are also prone to corrosion.

A variety of anti-corrosion systems have been described in the past. Many corrosion inhibitors are aqueous dispersions containing a variety of components, e.g., 2-mercaptobenzothiozole, benzotriozole, tolyltriozole, phosphates, polyphosphates, organic soluble polymers, silicates, dithiocarbamates, nitrites, oxazoles, imidazoles, imidazolines, ligands, liposulfates, tannins, phosphoric acid esters and boric acid esters. Many of these inhibitors are very prone to freezing during cold weather, making them very difficult to handle and maintain. Moreover, the useful life of many prior anti-corrosion treatments is very short, e.g., a week or less.

U.S. Pat. Nos. 5,936,059 and 5,945,164 describe highly useful anti-corrosion systems and methods particularly suited for oil and gas recovery and conveying equipment. The systems of the invention include an epoxy component as well as an amine curing agent component, which are either mixed together at the introduction site, or are simultaneously injected into a well or pipeline. A problem has arisen, however, when extremely long pipelines or deep wells require treatment. In such cases, the admixed epoxy and curing agent components tend to prematurely cure prior to application along the full length of the well or pipeline, meaning that certain portions of the equipment are not successfully treated. See also U.S. Pat. No. 4,526,813.

Oil and gas wells and transmission pipelines and equipment are prone to the build up of scale over extended periods. Scale formation in producing wells is very common on the interior surfaces of production tubing and equipment, and at perforations in the walls of the well casing. Sub-surface safety valves and like equipment are also susceptible to damage caused by scale formation. Similarly, scale build up can be encountered in all types of transmission lines and related hardware. Unless steps are taken to control scale formation, the useful life of these metallic components is significantly reduced.

In response to the scale problem, it has been common to inject scale inhibitors into producing wells or transmission lines. For example, organophosphates have been used in the past for this purpose, including methylene phosphonic acid or phosphonate compounds such as DETA phosphonate. However, to be effective these scale inhibitors should be continuously added to a well or the like in order to maintain an adequate concentration of the inhibitor in the flowing hydrocarbon product. This in turn necessitates the use of metering equipment and periodic replenishment of the supply of inhibitor. This can be an issue in remote or small-production wells where the effort and cost associated with metered scale inhibition represents a significant cost.

### SUMMARY OF THE INVENTION

The present invention overcomes the problems outlined above and provides multiple-component compositions for treatment of metallic surfaces subjected to contact with hydrocarbons, in order to protect such surfaces both corrosion and scale build up. Broadly speaking, such compositions include an epoxy resin, a cross-linking or curing agent for the epoxy resin, and a scale inhibitor which includes phosphonic acid or phosphonate moieties. The epoxy resin and agent are operable to form anti-corrosion coatings on the metallic surfaces, whereas the scale inhibitor is operable to react with the epoxy in order to provide long-term scale inhibition.

In preferred forms, the components of the compositions are applied as unitary, three-component compositions, or the epoxy component is first applied, followed by the cross-linking or curing agent, and scale inhibitor. Normally, the entire amount of scale inhibitor is applied within at least about 4 hours after application of the epoxy and cross-linking or curing agent.

In preferred forms the cross-linking or curing agent is selected from the alkoxylated amines and imidazolines and mixtures thereof, particularly ethoxylated tallow amine. The scale inhibitor is preferably an organic phosphonic acid or phosphonate such as DETA phosphonate.

The scale inhibitor is believed to react with the epoxy component and slowly migrates from the epoxy to maintain an effective level of scale inhibitor in the hydrocarbons flowing past the protected metal surfaces for a substantial period of time, e.g., at least about 7 days, and more preferably at least about 12 days. Hence, the need to continuously add scale inhibitor is eliminated.

### DETAILED DESCRIPTION OF THE PREFERRED EMBODIMENTS

The treatment compositions of the invention include at least three components, namely an epoxy component, a cross-linking or curing agent component, and a scale inhibitor component. Each of these components has an important function in the compositions and methods hereof, as will be explained.

### Epoxy Component

A variety of epoxies can be used in the invention. Generally, any epoxy resin having, on the average, more than one vicinal epoxy group per molecule can be used in the composition and process of the invention. The epoxy resin may be saturated or unsaturated, aliphatic, cycloaliphatic, aromatic or heterocyclic, and may bear substituents which do not materially interfere with the curing reaction.

Suitable epoxy resins include glycidyl ethers prepared by the reaction of epichlorohydrin with a compound containing a hydroxyl group (e.g., bisphenol A) carried out under alkaline reaction conditions. Other suitable epoxy resins can be prepared by the reaction of epichlorohydrin which mononuclear di- and ti-hydroxy phenolic compounds such as resorcinol and phloroglucinol, selected polynuclear polyhydroxy phenolic compounds such as bis(p-hydroxyphenyl)methane and 4,4′-dihydroxy biphenyl, or aliphatic polyols such as 1,4-butanediol and glycerol.

Epoxy resins suitable for use in the invention have molecular weights generally within the range of 50 to about 10,000, preferably about 1500 to about 2000. The commercially available Epon 828 epoxy resin, a reaction product of epichlorohydrin and 2,2-bis(4-hydroxyphenyl)propane (bisphenol A) and having a molecular weight of about 400, an epoxide equivalent (ASTM D-1652) of about 185-192, is presently preferred.

Additional epoxy-containing materials suitable for use in the present invention include the epoxidized derivatives of natural oils such as the triesters of glycerol with mixed long-chain saturated and unsaturated acids which contain, e.g., 16, 18 and 20 carbon atoms. Soybean oil is a typical triglyceride which can be converted to a polyepoxide suitable for use in the instant invention.

Other polyepoxides suitable for use in the present invention are derived from esters of polycarboxylic acids such as maleic acid, terephthalic acid, oxalic acid, succinic acid, azelaic acid, malonic acid, tartaric acid, adipic acid and the like, with unsaturated alcohols.

In addition to the foregoing, it is contemplated that suitable polyepoxides can be derived from esters prepared from unsaturated alcohols and unsaturated carboxylic acids. Representative epoxidized esters include the following: 2,3-epoxypentyl-3,4-epoxybutyrate; 2,3-epoxybutyl-3,4-epoxyhexanoate; 3,4-epoxyoctyl-2,3-epoxycyclohexane carboxylate; 2,3-epoxydodecyl-4,5-epoxyoctanoate; 2,3-epoxyisobutyl-4,5-epoxydodecanoate; 2,3-epoxycyclododedcyl-3,4-epoxypentanoate; 3,4-epoxyoctyl-2,3-epoxycyclododecane carboxylate and the like.

Other unsaturated materials which can be epoxidized to give resins suitable for use include butadiene based polymers such as butadiene-styrene copolymers, polyesters available as derivatives of polyols such as ethylene glycol with unsaturated acid anhydrides such as maleic anhydride and esters of unsaturated polycarboxylic acids. Representative polyepoxides derived from the latter include the following: dimethyl 3,4,7,8-diepoxydecanedioate; dibutyl 3,4,5,6-diepoxycyclohexane-1,2-carboxylate; dioctyl 3,4,7,8-diepoxyhexadecanedioate; diethyl 5,6,9,10-diepoxytetradecanedioate and the like.

Dimers of dienes such as 4-vinyl cyclohexene-1 from butadiene and dicyclopentadiene from cyclopentadiene can be converted to epoxidized derivatives which are suitable for use.

### Cross-Linking Component

The preferred cross-linking or curing agents are the alkoxylated amine agents, and may be aliphatic, cycloaliphatic, aromatic or heterocyclic. Particularly preferred are the alkoxylated polyamines, especially the alkoxylated N-alkyl- and N-alkylenyl-substituted 1,3-diaminopropanes and mixtures thereof. Examples of such alkoxylated polyamines include alkoxylated N-hexadecyl-1,3-diaminopropane, N-tetradecyl-1,3-diaminopropane, N-octadecyl-1,3-diaminopropane, -pentadecyl-1,3-diaminopropane, N-heptadecyl-1,3-diaminopropane, N-nonadecyl-1,3-diaminopropane, and N-octadecenyl-1,3-diaminopropane. Various commercially available mixtures of ethoxylated-alkylated and N-alkenylated diamines can be used in the invention. The presently preferred polyamine is a commercial product, ethoxylated-tallow-1,3-diaminopropane, where the degree of ethoxylation is approximately 10 moles ethoxylate per mole of tallow diamine.

Various imidazoline derivatives can be employed in the invention and the most preferred derivatives are set forth in the following structural formula:

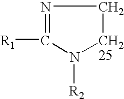

wherein R₁ is hydrogen or an alkyl group having up to 18 carbon atoms therein, and R₂ is hydrogen, or an alkyl or amine group having up to 18 carbon atoms therein.

Generally, the curing or cross-linking agent is used at levels to provide a curing or cross-linking agent:epoxy weight ratio of from about 1-3, and more preferably from about 1-2, in the ingredients as applied to a metal surface.

### Scale Inhibitor Component

A wide variety of scale inhibitors can be used in the invention, and these generally include phosphonic acid or phosphonate moieties in either or both tautameric form, i.e., the moieties are of the formula

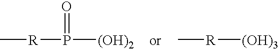

where R is selected from the group consisting of C1-C6 straight or branched chain alkyl, alkenyl or alkynyl groups. Alkylene phosphonic acid or phosphonate moieties are especially useful, where R is a methylene group, leading to scale inhibitors having alkylene phosphonic acid or alkylene phosphonate moieties.

Organophosphonates are particularly preferred as scale inhibitors, such as those of the formula

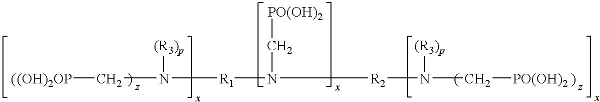

wherein each R₁ and R₂ is individually and independently selected from the group consisting of C1-C12 straight, branched or cyclic alkyl, alkenyl and alkynyl groups,

each R₃ is individually and independently selected from the group consisting of H and C1-C4 straight or branched chain alkyl groups,

each x is individually and independently 0 or 1, with at least one x being 1,

each z is individually and independently 1 or 2, and

each p is individually and independently 0 or 1, but if a z of a moiety is 2 the associated p of the same moiety is 0. It should be understood that while the above formula illustrates one tautamer of the methylene phosphonic acid or phosphonate moieties, it is equally applicable to the other tautamer as well.

Exemplary organophosphates useful as scale inhibitors in the invention include hexamethylene diamine tetrakis (methylene phosphonic acid); diethylene tramine tetra (methylene phosphonic acid); diethylene triamine penta (methylene phosphonic acid) (DETA phosphonate); and bis-hexanethylene triamine pentakis (methylene phosphonic acid) (BHMT phosphonate).

The presently most preferred three-component compositions of the invention include EPON 828 epoxy dispersed in heavy aromatic naptha, ethoxylated tallow-1,3 propylene diamene cross-linking or curing agent likewise dispersed in heavy aromatic naptha and having from about 2-15 moles of ethoxylate per mole of tallow diamene, and the DETA phosphonate anti-scaling component dispersed in a suitable solvent such as methanol or methanol/ethylene glycol. These components can be mixed together in a unitary composition, but more preferably the anti-scaling agent is added subsequent to the application of the epoxy component. In terms of relative amounts (whether in a unitary composition or as separate ingredients), the epoxy should be present at a level of from about 0.5-20% by weight (more preferably from about 3-10% by weight) in the three-component system, whereas the cross-linking or curing component should be use at a level of from about 0.5-60% by weight (more preferably from about 5-25% by weight), and the anti-scaling component should be present at a level of from about 0.5-60% by weight (more preferably from about 3-15% by weight).

The compositions of the invention may be applied in a variety of ways. For example, in one method the three components, i.e., the epoxy, the curing or cross-linking agent, and the scale inhibitor, can be combined to form a single unitary composition. In most cases, these respective components are dispersed in individual liquid dispersants, and thus the unitary composition is itself a liquid. Such a unitary composition should be promptly applied to the surfaces to be treated, so as to avoid premature reaction between the epoxy and the curing or cross-linking agent. Generally, such applications should occur within 1 hour of forming such a unitary composition.

In another application technique, the epoxy component is first contacted with the metallic surfaces to be treated, followed by the curing or cross-linking agent and scale inhibitor. In such cases the latter two components may be added together or seriatum. For ease of application, it is generally preferred to first add the curing agent, followed immediately by addition of scale inhibitor. Generally, it is preferred that the scale inhibitor component be added in its entirety within about 4 hours (more preferably about 2 hours) after the epoxy and cross-linking or curing agent have been added, thereby avoiding the expense and bother of metering scale inhibitor into a well or the like over an extended time period.

However applied, the compositions of the invention provide a high degree of corrosion resistance coupled with relatively long-term scale inhibition. In most uses, a single application of a composition in accordance with the invention will provide adequate and effective scale inhibition for a period of at least seven days, and more preferably at least 12 days. Such scale inhibition is manifested by a slow release of the scale inhibitor over time, which may progressively decrease in concentration of scale inhibitor day-to-day. The final three-components of the invention as applied to a metal surface should include from about 1-50% by weight epoxy (more preferably from about 25-50% by weight), from about 1-50% by weight curing or cross-linking agent (more preferably from about 25-50% by weight), and from about 1-50% by weight scale inhibitor (more preferably from about 15-25% by weight).

While not wishing to be bound to any theory of operation, it is believed that the epoxy and curing or cross-linking agent forms an anti-corrosion coating or layer these metallic surfaces, whereas the scale inhibitor in some fashion reacts with or is attracted to the epoxy component. The nature of this reaction is not fully understood, except that it does create a situation where the scale inhibitor slowly migrates from the anti-corrosion coating to provide the desired long-term scale inhibition. Therefore, the term “reacts” in this context should be understood to embrace all types of operative interactions between the scale inhibitor and epoxy, including classical covalent chemical reactions and other attractions not commonly considered to be chemical reactions.

The compositions of the invention can be used to coat and protect a large number of metallic surfaces subject to contact with liquid or gaseous hydrocarbons. These surfaces may form a part of down-hole well equipment (e.g., casings, sucker rods, pumps, etc.) as well as oil or gas transmission equipment (e.g., pipelines, pumps). Moreover, while the three-component compositions are preferred, it will be appreciated that other components can also be added, such as anti-bacterial agents or surfactants.

The following example sets forth presently preferred compositions and methods in accordance with the invention. It is to be understood, however, that these examples are provided by way of illustration and nothing therein should be taken as a limitation upon the overall scope of the invention.

### Example

In this example, six producing oil wells were treated using a preferred, 3-component composition to provide excellent corrosion and scale inhibition. Each well was treated using 50 bbls of fresh water, as follows. First, the well was wetted with 5 bbl of water, whereupon 4 qts of 20% by volume epoxy resin (EPON 828, Shell Chemical Company) dispersed in heavy aromatic naptha were added to the well. The well was next flushed with 5 bbls of water and 12 qts of known epoxy cross linking agent was added, namely a 60% by volume dispersion of tallow-1,3-propylene diamene in heavy aromatic naptha and having about 2-15 moles of ethoxylate per mole of tallow diamene. Also, 2 qts of a known organophosphonate scale inhibitor were added to the well, specifically a 20% by volume diethylene triamine penta (methylene phosphonic acid) (DETA phosphonate) dispersed in methanol/ethylene glycol. The remainder of the fresh water was then flushed down the well to complete the treatment. All of the treatment steps were carried out without any substantial waiting periods between the separate well additions.

The levels of residual DETA phosphonate in the well process water were then measured over a twelve day period beginning three days after the treatment, using a standard, art-recognized assay. The results of these treatments are set forth in the following table,

wherein the “Day” columns represent the daily residual organophosphate levels determined, in ppm. This data demonstrates that the corrosion inhibitor is maintained in the well water at useful levels over a substantial period of time.

In subsequent treatments of these wells, the amounts of treating chemicals can be reduced, e.g., to 2 qts of the epoxy, 6 qts of the cross-linking agent and 2 qts of the corrosion inhibitor. It is believed that bi-monthly treatment of the wells will maintain adequate anti-corrosion and scale inhibition.

| | Well | | | | | | | | | | | | |
|---|---|---|---|---|---|---|---|---|---|---|---|---|---|
| Well | Production | | | | | | | | | | Day | Day | Day |
| No. | (bbls/day) | Day 1 | Day 2 | Day 3 | Day 4 | Day 5 | Day 6 | Day 7 | Day 8 | Day 9 | 10 | 11 | 12 |
| 1 | 40 | 11 | 11 | 9 | 7 | 7 | 7 | 5 | 6 | 5 | 5 | 4 | 11 |
| 2 | 40 | 19 | 16 | 13 | 12 | 12 | 10 | 8 | 8 | 5 | 4 | 3 | 3 |
| 3 | 40 | 22 | 8 | 8 | 15 | 8 | — | 12 | 12 | 10 | 10 | 8 | 8 |
| 4 | 40 | 6 | 3 | 6 | 6 | 6 | 6 | 6 | 6 | 6 | 6 | 6 | 6 |
| 5 | 61 | 6 | 5 | 4 | 8 | 8 | 7 | 8 | 6 | 6 | 4 | 5 | 6 |
| 6 | 40 | 10 | 10 | 9 | 9 | 8 | 8 | 7 | 7 | 7 | 6 | 4 | 4 |

We claim:

1. A method of treating a metallic surface subject to contact with hydrocarbons, said method comprising the steps of:
forming on said surface an anti-corrosion coating comprising an epoxy resin reacted with a curing or cross-linking agent for the epoxy resin; and
reacting a scale inhibitor with said epoxy.

2. The method of claim 1, said scale inhibitor operable to establish and maintain an effective level of corrosion inhibition in hydrocarbons contacting said surface for a period of at least seven days.

3. The method of claim 2, said period being at least 12 days.

4. The method of claim 1, said curing or cross-linking agent selected from the group consisting of alkoxylated amines and imidazolines and mixtures thereof.

5. The method of claim 4, said agent being an alkoxylated tallow amine having from about 2-15 moles of alkoxylate per mole of tallow amine.

6. The method of claim 5, said agent having from about 3-10 moles of alkoxylate per mole of tallow amine.

7. The method of claim 5, said curing agent being an ethoxylated tallow amine.

8. The method of claim 1, the weight ratio of said agent to said epoxy being from about 1-3 parts by weight agent for each part by weight epoxy.

9. The method of claim 1, said scale inhibitor including phosphonic acid or phosphonate moieties of the formula 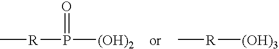
where R is selected from the group consisting of C1-C6 straight or branched chain alkyl, alkenyl or alkynyl groups.

10. The method of claim 9, wherein R is methylene.

11. The method of claim 1, said scale inhibitor selected from the group consisting of 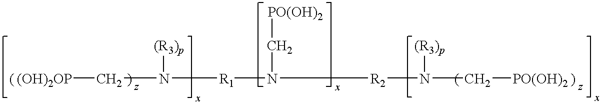
wherein each R₁ and R₂ is individually and independently selected from the group consisting of C1-C12 straight, branched or cyclic alkyl, alkenyl and alkynyl groups,
each R₃ is individually and independently selected from the group consisting of H and C1-C4 straight or branched chain alkyl groups,
each x is individually and independently 0 or 1, with at least one x being 1,
each z is individually and independently 1 or 2, and
each p is individually and independently 0 or 1, but if a z of a moiety is 2, the associated p within the same moiety is 0.

12. The method of claim 1, including the steps of combining said epoxy, agent, and scale inhibitor to form a unitary composition, and contacting said surface with said composition.

13. The method of claim 1, including the steps of combining said scale inhibitor and agent into a mixture separate from said epoxy, contacting said surface with said epoxy, and thereafter contacting the epoxy-coated surface with said mixture.

14. The method of claim 1, said epoxy, agent, and scale inhibitor each being separate, including the steps of contacting said surface with said epoxy and agent to form an anti-corrosive layer, and thereafter contacting said layer with said scale inhibitor.

15. A metallic object presenting a metallic surface, and a coating applied to said surface, said coating comprising an epoxy, a curing or cross-linking agent reacted with said epoxy, and a scale inhibitor reacted with said epoxy.

16. The object of claim 15, said scale inhibitor operable to establish and maintain an effective level of corrosion inhibition in hydrocarbons contacting said surface for a period of at least seven days.

17. The object of claim 16, said period being at least 12 days.

18. The object of claim 15, said curing or cross-linking agent selected from the group consisting of alkoxylated amines and imidazolines and mixtures thereof.

19. The object of claim 18, said curing agent being an ethoxylated tallow amine.

20. The object of claim 15, the ratio of said agent to said epoxy being from about 1-4 parts by weight agent for each part by weight epoxy.

21. The object of claim 15, said scale inhibitor including phosphonic acid or phosphonate moieties of the formula 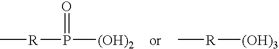
where R is selected from the group consisting of C1-C6 straight or branched chain alkyl, alkenyl or alkynyl groups.

22. The object of claim 21, wherein R is methylene.

23. The object of claim 15, said scale inhibitor selected from the group consisting of 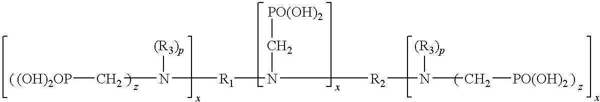
wherein each R₁ and R₂ is individually and independently selected from the group consisting of C1-C12 straight, branched or cyclic alkyl, alkenyl and alkynyl groups,
each R₃ is individually and independently selected from the group consisting of H and C1-C4 straight or branched chain alkyl groups,
each x is individually and independently 0 or 1, with at least one x being 1,
each z is individually and independently 1 or 2, and
each p is individually and independently 0 or 1, but if a z of a moiety is 2, the associated p within the same moiety is 0.

24. The object of claim 15, said object selected from the group consisting of hydrocarbon well equipment and hydrocarbon transmission equipment.
